(19) United States
(12) Patent Application Publication
(10) Pub. No.: US 2014/0163986 A1
(43) Pub. Date: Jun. 12, 2014

(54) VOICE-BASED CAPTCHA METHOD AND APPARATUS

(71) Applicant: Electronics and Telecommunications Research Institute, Daejeon (KR)

(72) Inventors: Sung-Joo LEE, Daejeon (KR); Ho-Young JUNG, Daejeon (KR); Hwa-Jeon SONG, Daejeon (KR); Eui-Sok CHUNG, Daejeon (KR); Byung-Ok KANG, Daejeon (KR); Hoon CHUNG, Hongcheon-gun Gangwon-do (KR); Jeon-Gue PARK, Daejeon (KR); Hyung-Bae JEON, Daejeon (KR); Yoo-Rhee OH, Daejeon (KR); Yun-Keun LEE, Daejeon (KR)

(73) Assignee: Electronics and Telecommunications Research Institute, Daejeon (KR)

(21) Appl. No.: 14/095,622

(22) Filed: Dec. 3, 2013

(30) Foreign Application Priority Data
Dec. 12, 2012 (KR) 10-2012-0144161

(51) Int. Cl. G10L 15/02

(52) U.S. Cl. CPC G10L 15/02
USPC 704/248

(57) ABSTRACT

Disclosed herein is a voice-based CAPTCHA method and apparatus which can perform a CAPTCHA procedure using the voice of a human being. In the voice-based CAPTCHA) method, a plurality of uttered sounds of a user are collected. A start point and an end point of a voice from each of the collected uttered sounds are detected and then speech sections are detected. Uttered sounds of the respective detected speech sections are compared with reference uttered sounds, and then it is determined whether the uttered sounds are correctly uttered sounds. It is determined whether the uttered sounds have been made by an identical speaker if it is determined that the uttered sounds are correctly uttered sounds. Accordingly, a CAPTCHA procedure is performed using the voice of a human being, and thus it can be easily checked whether a human being has personally made a response using a voice online

### CROSS REFERENCE TO RELATED APPLICATION

This application claims the benefit of Korean Patent Application No. 10-2012-0144161 filed on Dec. 12, 2012, which is hereby incorporated by reference in its entirety into this application.

### BACKGROUND OF THE INVENTION

1. Technical Field

The present invention relates generally to a voice-based Completely Automated Public Turing test to tell Computers and Humans Apart (CAPTCHA) method and apparatus and, more particularly, to a CAPTCHA method and apparatus based on the voice of a user.

2. Description of the Related Art

CAPTCHA is an abbreviated form of Completely Automated Public Turing test to tell Computers and Humans Apart, and is used to identify users who access a web server to subscribe as members, to participate in carrying out a survey, and to perform other operations.

CAPTCHA provides a CAPTCHA question to users who access the web server and allows only users who give an answer to the CAPTCHA question to use the web server. CAPTCHA provides a question that is difficult for an automated program to solve, thus preventing the automated program from using the web server and allowing only human beings to use the web server. Such an automated program may be a bot program or the like.

That is, a CAPTCHA scheme is used to identify whether a respondent is an actual human being or a computer program through tests designed to be easy for a human being to solve, but difficult for a computer to solve using current computer technology. Such a CAPTCHA scheme has played an important role as an effective solution to security problems on the web. For example, when a certain user desires to access a predetermined website and generate his or her identification (ID) (in the case of member subscription), the CAPTCHA scheme presents a CAPTCHA test to the corresponding user, and allows only a user who gives a correct response to the presented test to generate the ID. By way of this function, the automatic generation of ID using a malicious hacking program (bot program) is prevented, thus enabling the sending of spam mail, the fabrication of the results of surveys, etc. to be prohibited.

Among CAPTCHA tests, the most typical CAPTCHA question is a text (character)-based CAPTCHA scheme which intentionally distorts text and requires users to recognize the text. However, in this case, as Optical Character Recognition (OCR) technology has been developed, a conventional text-based CAPTCHA scheme is problematic in that security may be breached by an automated program (that is, by a computer). Furthermore, as it is revealed that the capability of a computer to recognize characters is similar to or higher than that of a human being (disclosed in a 2005 paper entitled “Designing Human Friendly Human Interaction Proofs”), the improvement of the text-based CAPTCHA scheme has been required.

Korean Unexamined Patent Publication No. 10-2012-0095124 (entitled “Image-based CAPTCHA method and storage medium for storing program instructions for the method”) discloses technology for storing an image, in which the number of human beings who appear is checked by a plurality of users, in a question database (DB) for CAPTCHA, and presenting the image as a test question, thus not only greatly decreasing a possibility of a computer recognizing the image, but also decreasing a possibility of a user presenting a false response. For this function, the invention disclosed in Korean Unexamined Patent Publication No. 10-2012-0095124 includes the step of providing an image from a CAPTCHA image DB to a client; the step of asking a user a question about the number of persons appearing on the provided image through the client; the step of requiring the user to input the number of persons corresponding to an answer to the question to the client; and the step of comparing the number of persons in each input answer with the number of persons in a correct answer stored in the CAPTCHA image DB, and authenticating the corresponding user as a human being if the number of persons in the input answer is identical to the number of persons in the correct answer.

The invention disclosed in Korean Unexamined Patent Publication No. 10-2012-0095124 performs authentication based on images.

Korean Unexamined Patent Publication No. 2012-0095125 (entitled “Facial picture-based CAPTCHA method and storage medium for storing program instructions for the method”) discloses technology for selecting an image element, from a facial picture, that is difficult for a computer to recognize, and presenting the selected image element as a CAPTCHA question. For this function, the invention disclosed in Korean Unexamined Patent Publication No. 10-2012-0095125 includes the step of providing a facial picture on which the face of a human being is displayed to a client; and the step of asking a user a question about a specific image element of the provided facial picture through the client, wherein the specific image element is an element that is recognized by a computer at a precision lower than a predetermined level or is not recognized at all.

In this way, the above-described technology disclosed in Korean Unexamined Patent Publication No. 10-2012-0095125 uses an image element, from a facial picture, that is difficult for the computer to recognize.

### SUMMARY OF THE INVENTION

Accordingly, the present invention has been made keeping in mind the above problems occurring in the prior art, and an object of the present invention is to provide a voice-based CAPTCHA method and apparatus, which can perform a CAPTCHA procedure using the voice of a human being.

In accordance with an aspect of the present invention to accomplish the above object, there is provided a voice-based Completely Automated Public Turing test to tell Computers and Humans Apart (CAPTCHA) method, including collecting, by a voice collection unit, a plurality of uttered sounds of a user; detecting, by a speech section detection unit, a start point and an end point of a voice from each of the plurality of collected uttered sounds, and then detecting speech sections; comparing, by a uttered sound comparison unit, uttered sounds of the respective detected speech sections with reference uttered sounds, and then determining whether the uttered sounds are correctly uttered sounds; and determining, by a speaker authentication unit, whether the plurality of uttered sounds have been made by an identical speaker if it is determined that the uttered sounds are correctly uttered sounds.

Preferably, each of the plurality of uttered sounds may include two character or number strings.

In accordance with another aspect of the present invention to accomplish the above object, there is provided a voice-based Completely Automated Public Turing test to tell Computers and Humans Apart (CAPTCHA) apparatus, including a voice collection unit for collecting a plurality of uttered sounds of a user; a speech section detection unit for detecting a start point and an end point of a voice from each of the plurality of collected uttered sounds, and then detecting speech sections; an uttered sound comparison unit for comparing uttered sounds of the respective detected speech sections with reference uttered sounds, and then determining whether the uttered sounds are correctly uttered sounds; and a speaker authentication unit for determining whether the plurality of uttered sounds have been made by an identical speaker if it is determined by the uttered sound comparison unit that the uttered sounds are correctly uttered sounds.

Preferably, the voice collection unit may include a microphone.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a voice-based CAPTCHA apparatus according to an embodiment of the present invention; and

FIG. 2 is a flowchart showing a voice-based CAPTCHA method according to an embodiment of the present invention.

### DESCRIPTION OF THE PREFERRED EMBODIMENTS

Hereinafter, a voice-based CAPTCHA method and apparatus according to embodiments of the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

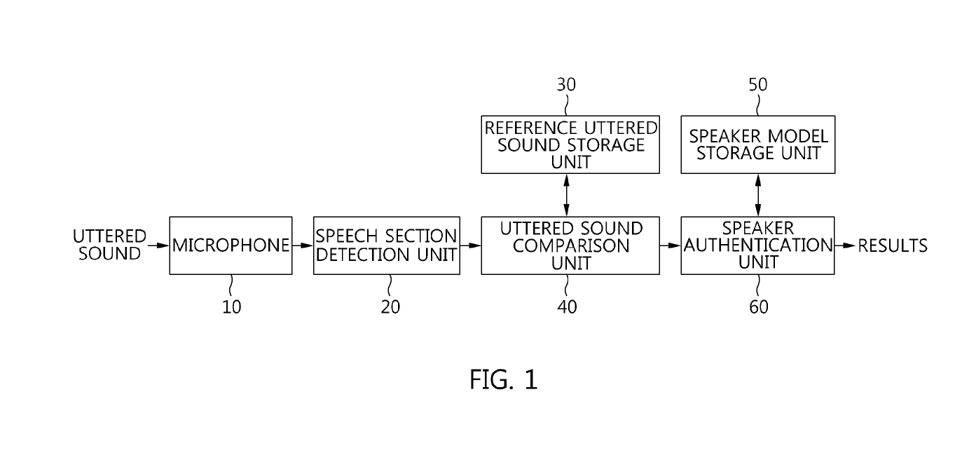

FIG. 1 is a configuration diagram showing a voice-based CAPTCHA apparatus according to an embodiment of the present invention.

The voice-based CAPTCHA apparatus according to the embodiment of the present invention includes a microphone 10, a speech section detection unit 20, a reference uttered sound storage unit 30, an uttered sound comparison unit 40, a speaker model storage unit 50, and a speaker authentication unit 60.

The microphone 10 collects a plurality of uttered sounds of a user. Here, each of the plurality of uttered sounds includes at least two character strings or at least two number strings. The microphone 10 is an example of a voice collection unit described in the accompanying claims of the present invention.

The speech section detection unit 20 detects the start point and the end point of a voice from each of the plurality of uttered sounds collected by the microphone 10, using speech endpoint detection technology, and then detects speech sections. Here, the speech endpoint detection technology may be sufficiently understood using well-known technology by those skilled in the art.

The reference uttered sound storage unit 30 stores a plurality of reference uttered sounds. Here, each of the reference uttered sounds includes at least two character strings or at least two number strings. Preferably, information stored in the reference uttered sound storage unit 30 is implemented by obtaining statistical models used by a voice recognition system and a speech verification system from a human voice corpus. Therefore, the stored information has characteristics different from those of artificial voice signals reproduced by a Text-To-Speech (TTS) system. Since the voice signals reproduced by the TTS system have relatively low reliability, the uttered sound comparison unit 40 may consequently filter artificial voices more naturally than the TTS system. Further, the stored information includes even uttered sounds that current TTS technology has difficulty synthesizing, and thus if these uttered sounds are sufficiently utilized, the performance of the system can be secured. Here, the voice recognition system and the speech verification system can be sufficiently understood by those skilled in the art using well-known technology.

The uttered sound comparison unit 40 compares the uttered sounds of the respective speech sections detected by the speech section detection unit 20 with the corresponding reference uttered sounds stored in the reference uttered sound storage unit 30, and then determines whether the uttered sounds are correctly uttered sounds. In this case, the uttered sound comparison unit 40 utilizes voice recognition technology and speech verification technology. Here, the voice recognition technology and the speech verification technology can be sufficiently understood by those skilled in the art using well-known technology.

The speaker model storage unit 50 stores speaker models (or also referred to as ‘reference models’) based on the characteristics of voices of a plurality of speakers (users).

The speaker authentication unit 60 determines whether the plurality of input uttered sounds have been made by the same speaker if it is determined by the uttered sound comparison unit 40 that the uttered sounds are correctly uttered sounds. In this case, the speaker authentication unit 60 uses speaker authentication and speaker verification technology. Here, the speaker authentication and speaker verification technology can be sufficiently understood by those skilled in the art using well-known technology.

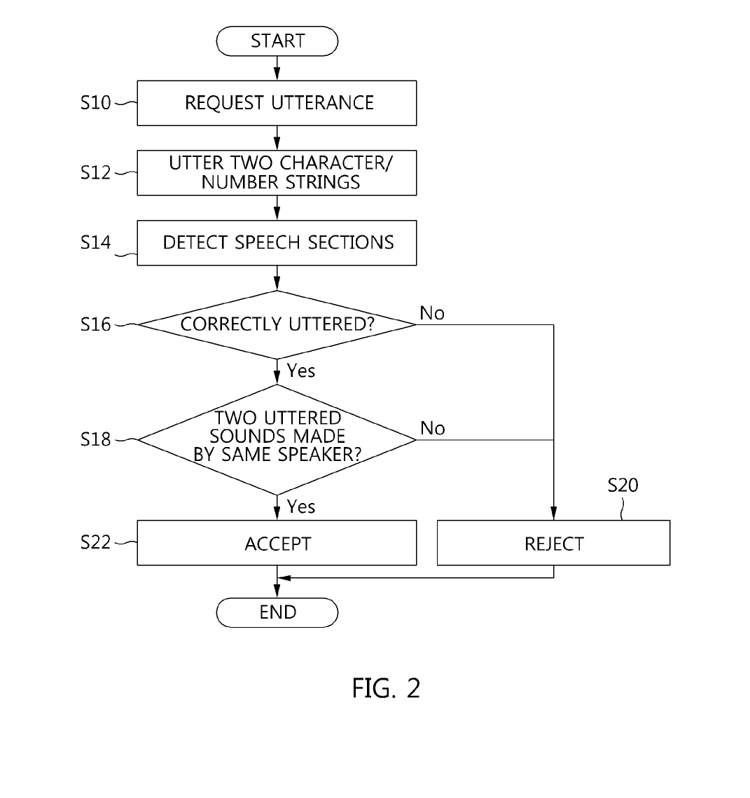

FIG. 2 is a flowchart showing a voice-based CAPTCHA method according to an embodiment of the present invention.

First, a user is requested to utter two character or number strings at step S10.

Accordingly, the user utters two character or number strings using a push-to-talk method at step S12.

The uttered sounds of the user are collected by the microphone 10 and are transferred to the speech section detection unit 20. The speech section detection unit 20 detects the start point and the end point of each of a plurality of uttered sounds collected by the microphone 10 using speech endpoint detection technology, and then detects speech sections at step S14.

The detected speech sections for the plurality of uttered sounds are transferred to the uttered sound comparison unit 40. The uttered sound comparison unit 40 compares the uttered sounds of the respective speech sections with corresponding reference uttered sounds (that is, reference character or number strings) stored in the reference uttered sound storage unit 30 using voice recognition technology and speech verification technology. Accordingly, the uttered sound comparison unit 40 determines whether the uttered sounds are correctly uttered sounds at step S16.

If it is determined that the uttered sounds are correctly uttered sounds (that is, the uttered sounds are able to recognized as the reference uttered sounds) (in case of “Yes” at step S16), the uttered sound comparison unit 40 transfers a plurality of correctly uttered sounds to the speaker authentication unit 60. Accordingly, the speaker authentication unit 60 determines whether the plurality of input uttered sounds have been made by the same speaker at step S18.

As a result of the determination, if it is determined that the input uttered sounds have not been made by the same speaker (in case of “No” at step S18), the speaker authentication unit 60 rejects the uttered sounds input by the user at step S20.

On the contrary, if it is determined that the input uttered sounds have been made by the same speaker (in case of “Yes” at step S18), the speaker authentication unit 60 accepts the uttered sounds input by the user at step S22.

In accordance with the present invention having the above configuration, a CAPTCHA procedure is performed using the voice of a human being, and thus it can be easily checked whether a human being has personally made a response using his or her voice online

Although the preferred embodiments of the present invention have been disclosed for illustrative purposes, those skilled in the art will appreciate that various changes and modifications are possible, without departing from the scope and spirit of the invention. It should be understood that the technical spirit of those changes and modifications belong to the scope of the claims.

What is claimed is:

1. A voice-based Completely Automated Public Turing test to tell Computers and Humans Apart (CAPTCHA) method, comprising:
collecting a plurality of uttered sounds of a user;
detecting a start point and an end point of a voice from each of the plurality of collected uttered sounds, and then detecting speech sections;
comparing uttered sounds of the respective detected speech sections with reference uttered sounds, and then determining whether the uttered sounds are correctly uttered; and
determining whether the plurality of uttered sounds have been made by an identical speaker if it is determined that the uttered sounds are correctly uttered sounds.

2. The voice-based CAPTCHA method of claim 1, wherein each of the plurality of uttered sounds includes two character or number strings.

3. A voice-based Completely Automated Public Turing test to tell Computers and Humans Apart (CAPTCHA) apparatus, comprising:
a voice collection unit for collecting a plurality of uttered sounds of a user;
a speech section detection unit for detecting a start point and an end point of a voice from each of the plurality of collected uttered sounds, and then detecting speech sections;
an uttered sound comparison unit for comparing uttered sounds of the respective detected speech sections with reference uttered sounds, and then determining whether the uttered sounds are correctly uttered sounds; and
a speaker authentication unit for determining whether the plurality of uttered sounds have been made by an identical speaker if it is determined by the uttered sound comparison unit that the uttered sounds are correctly uttered sounds.

4. The voice-based CAPTCHA apparatus of claim 3, wherein the voice collection unit comprises a microphone.

5. The voice-based CAPTCHA apparatus of claim 3, wherein each of the plurality of uttered sounds includes two character or number strings.
